(19) United States
(12) Patent Application Publication
(10) Pub. No.: US 2026/0084515 A1
(43) Pub. Date: Mar. 26, 2026

(54) POWER-ASSISTED WHEEL INTEGRATED WITH DRIVE AND POWER SUPPLY AND ROLLATOR

(71) Applicant: D & S Electronic Products(Shenzhen)Limited, Shenzhen (CN)

(72) Inventors: Fai Hang Alfred WONG, Shenzhen (CN); Fei Long, Shenzhen (CN); Jianyou Wang, Shenzhen (CN)

(21) Appl. No.: 18/897,391

(22) Filed: Sep. 26, 2024

(51) Int. Cl. B60K 7/00; B60K 1/04; B60K 17/04; B60L 15/20

(52) U.S. Cl. CPC B60K 7/0007; B60K 1/04; B60K 17/043; B60L 15/20; B60K 2001/0405; B60L 2200/24

(57) ABSTRACT

A power-assisted wheel assembly integrated with drive and power supply and a rollator are provided, the power-assisted wheel assembly includes a wheel hub, a tire sleeved on the wheel hub, a wheel axle rotating relative to the wheel hub, and a sealed accommodation cavity provided in the wheel hub. The accommodation cavity is provided with a battery and a motor, the motor is connected to the wheel hub for transmission; the accommodation cavity is provided with an electronic control board, which is electrically connected to the battery and the motor. The battery supplies power to the electronic control board and the motor; the electronic control board is wirelessly connected to a remote control for controlling an operation of the motor. The power-assisted wheel assembly adopts a structure with built-in battery and motor, combined with wireless communication to achieve a full sealing of the wheel assembly.

### TECHNICAL FIELD

The present disclosure relates to the field of power-assisted wheel and rollator technologies, and in particular, to a power-assisted wheel integrated with drive and power supply and a rollator.

### BACKGROUND

The electric power-assisted wheels of existing electric baby strollers, campers, golf carts, and other products generally use external batteries, combined with electronic control and control handles for use. An integration of this power-assisted wheel assembly is low, and its structure is similar to that of existing electric bicycle wheels. A wheel hub of the power-assisted wheel assembly is a motor that runs by an external battery power. Thus, it is bulk and has a larger volume. For products with on-board usage scenarios, it is not very convenient to move them up and down from a cart, so a highly integrated, compact and lightweight power-assisted wheel assembly is needed.

### SUMMARY

In view of the above situation, it is necessary to provide a power-assisted wheel assembly integrated with drive and power supply and a rollator so as to solve at least one of the above problems.

A power-assisted wheel assembly that integrates with drive and power supply, including a wheel hub, a tire sleeved on the wheel hub, a wheel axle being capable of rotating relative to the wheel hub, and a closed accommodation cavity provided in the wheel hub; where the accommodation cavity is provided with a battery and a motor, the motor is connected to the wheel hub for transmission; the accommodation cavity is further provided with an electronic control board, which is electrically connected to the battery and the motor; the battery supplies power to the electronic control board and the motor; the electronic control board is wirelessly connected to a remote control for controlling an operation of the motor.

In some embodiments of the present disclosure: a bracket is provided in the accommodation cavity, and the bracket is fixedly connected to the wheel axle; the bracket is a flat plate; the battery, the motor, and the electronic control board are all fixed on a same side of the bracket.

In some embodiments of the present disclosure, the battery is a combination of a plurality of 18650 batteries, and the plurality of batteries are laid flat on the bracket (six batteries, providing 21.6 volts of power, with an electric quantity of 2600 milliampere; or ten batteries, providing 36 volts of power, with an electric quantity of 3600 milliampere).

In some embodiments of the present disclosure: an output end of the motor passes through one side of the bracket and protrudes from the other side of the bracket; a synchronous wheel is provided between the wheel hub and the bracket and provided on the other side of the bracket; the synchronous wheel is fixedly connected to the wheel hub, the synchronous wheel and the output end of the motor are transmitted through a belt.

In some embodiments of the present disclosure, a gear ratio between the synchronous wheel and the motor is 10:1.

In some embodiments of the present disclosure: the wheel axle is a quick detachable axle, and includes a hollow axle body, a lock rod provided in the axle body, a bead provided at one end of the axle body that is connected to a rollator, a button provided at the other end of the axle body, and a spring provided between the axle body and the lock rod; the button is exposed outside one side of the wheel hub; the lock rod is provided with a step at a position that the lock rod contacts to the bead; when the button is pressed, the lock rod is moved towards the rollator, and the bead is moved; when the button is released, the lock rod is rested, and the bead is locked under an elastic force of the spring.

A rollator includes the power-assisted wheel assembly.

The above-mentioned power-assisted wheel assembly adopts a structure with built-in battery and motor, combined with wireless communication to achieve a full sealing of the power-assisted wheel assembly, meeting a need of outdoor use. At the same time, it simplifies the existing power-assisted wheel assembly structure, fully utilizes an internal space of the wheel hub, reduces a volume of an electric power-assisted wheel assembly, and has advantages such as small volume and used for all road conditions.

### BRIEF DESCRIPTION OF DRAWINGS

FIG. 1 is a first schematic structural diagram provide by an embodiment of the present disclosure.

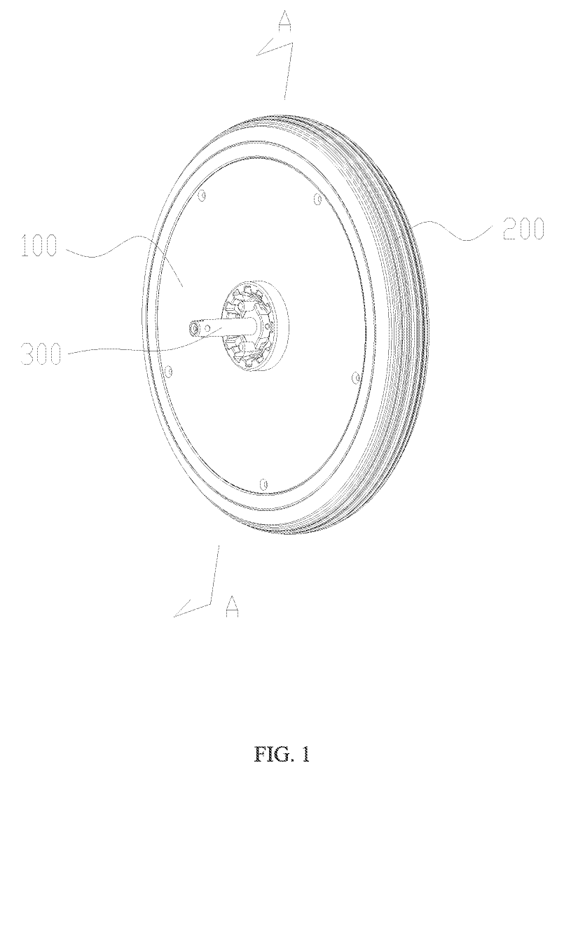

FIG. 2 is a second schematic structural diagram provided by the embodiment of the present disclosure.

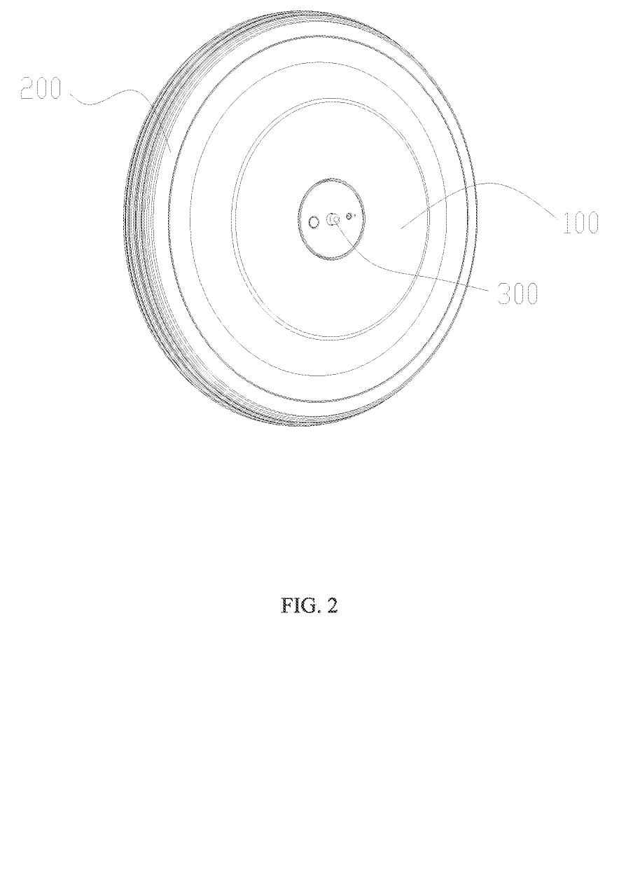

FIG. 3 is a cross-sectional view along line A-A in FIG. 1.

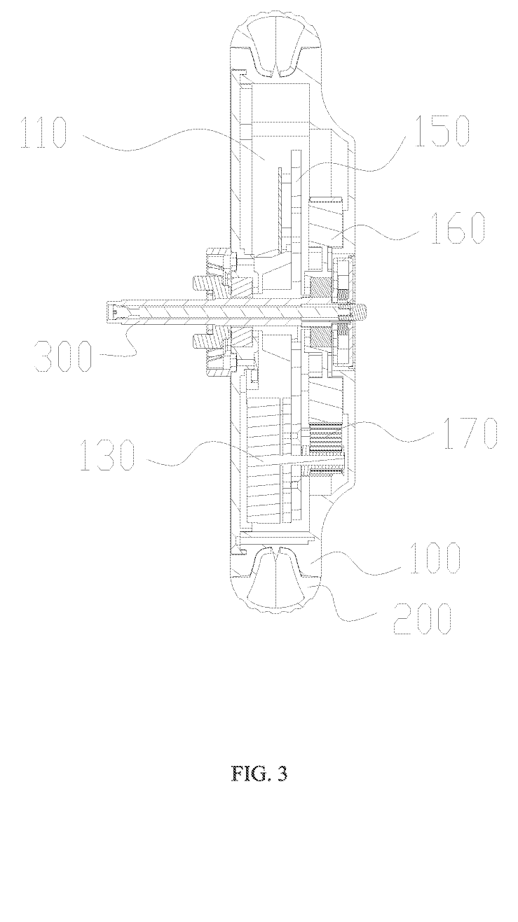

FIG. 4 is a sectional view of a wheel axle.

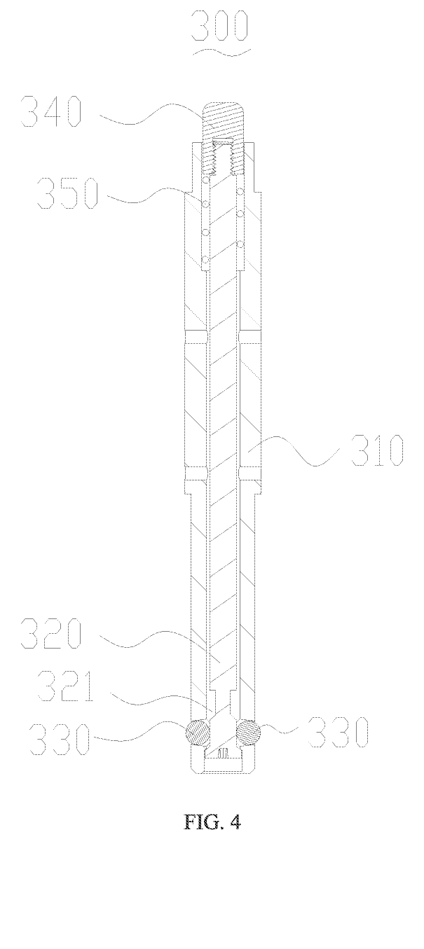

FIG. 5 is an exploded view provide by the embodiment of the present disclosure.

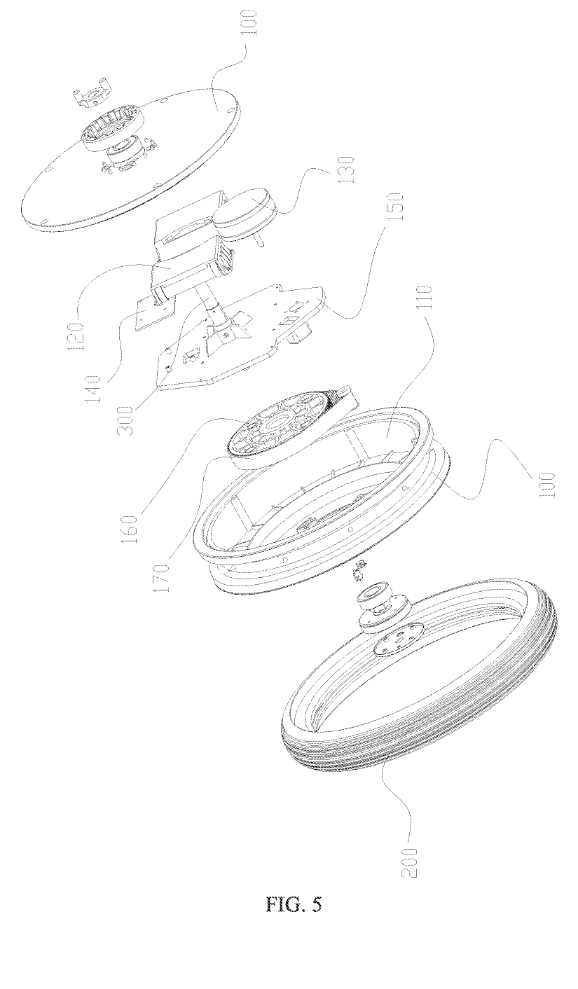

### DESCRIPTION OF EMBODIMENTS

In order to further clarify the purpose, technical solution, and advantages of the present disclosure, the following provides a detailed description of a power-assisted wheel assembly and a rollator, in combination with the accompanying drawings and embodiments. It should be understood that the specific embodiments described herein are only for explaining the present disclosure and are not intended to limit the present disclosure.

In a description of the present disclosure, unless otherwise specified, “a plurality of” means two or more; terms “center”, “vertical”, “horizontal”, “up”, “down”, “left”, “right”, “inside”, “outside”, “front”, “rear”, “head end”, “tail end”, “vertical”, “horizontal”, “top”, “bottom”, “inside”, “outside” and other directional or positional relationships indicated are based on a directional or positional relationships shown in the accompanying drawings and are only for a convenience of describing the present disclosure and simplifying the description, and do not indicate or imply that the device or element referred to must have a specific orientation, be constructed and operated in a specific orientation, and therefore cannot be understood as limiting the present disclosure. In addition, terms “first”, “second”, “third”, etc. are only used for a descriptive purpose and cannot be understood as indicating or implying relative importance.

In the description of the present disclosure, it should be noted that unless otherwise specified and limited, terms “installation”, “connection to”, and “connection with” should be broadly understood, for example, it can be a fixed connection, a detachable connection, or an integral connection; it can be a mechanical connection or an electrical connection; it can be a direct connection, an indirect connection through an intermediate medium, or connected internally between two components. For those skilled in the art, the specific meanings of the above terms in the present disclosure can be understood through specific situations.

The present disclosure provides a power-assisted wheel assembly that integrates with drive and power supply, including a wheel hub 100, a tire 200 sleeved on the wheel hub 100, a wheel axle 300 being capable of rotating relative to the wheel hub 100. It can be understood that the wheel axle 300 is fixed and only the wheel hub 100 rotates.

The wheel hub 100 is provided with a sealed accommodation cavity 110 inside; all electronic components are sealed in the accommodation cavity 110, thereby achieving full enclosure of the power-assisted wheel assembly, waterproof and dustproof, and can adapt to all outdoor and indoor usage scenarios.

The accommodation cavity 110 is provided with a battery 120 and a motor 130, the motor 130 is connected to the wheel hub 100 for transmission; the battery 120 supplies power to the motor 130, thereby driving the wheel hub 100 to rotate.

The accommodation cavity 110 is further provided with an electronic control board 140, which is electrically connected to the battery 120 and the motor 130. The battery 120 supplies power to the electronic control board 140 and the motor 130. The electronic control board 140 is wirelessly connected to a remote control for controlling an operation of the motor 130.

The power-assisted wheel assembly disclosed in the present application has high integration, achieves a sealing of the wheel hub, and is widely applicable in various scenarios. At the same time, based on wireless remote control, there is no any cable lead out and controlled through the remote control. Compared with the traditional electric wheel hub structure that requires control lines and power lines to be came out of the wheel axle, it eliminates a need for external cables and can achieve quick disassembly of the power-assisted wheel assembly and replacement of a wheel for an ordinary handcart.

In an implementation mode, a bracket 150 is provided inside the accommodation cavity 110, the bracket 150 is fixedly connected to the wheel axle 300. The bracket 150, like the wheel axle 300, is fixed and immovable after installation on any cart without power assistance. It is easy to deduce that other parts installed on the bracket 150 are also fixed and immovable.

The bracket 150 is a flat plate; in order to reduce a thickness of the wheel, a use of a flat bracket 150 can greatly reduce an axial space occupation of the accommodation cavity 110 and fully utilize a radial space of the accommodation cavity 110.

The battery 120, the motor 130, and the electronic control board 140 are all fixed on a same side of the bracket 150. In order to improve a space utilization of the accommodation cavity 110, all components of a driving part are set on the same side of the bracket 150, leaving the other side for a transmission structure of the wheel. In this embodiment, the aforementioned transmission structure is a belt 170 and a synchronous wheel 160. Considering that the motor needs to provide sufficient torque, that is, sufficient gear ratio, the synchronous wheel 160 will occupy a large space. Therefore, the battery 120, the motor 130, and the electronic control board 140 are provided on the same side of the bracket 150.

In an implementation mode, the battery 120 is a combination of a plurality of 18650 batteries (with a diameter of 18mm and a length of 65 mm for each battery), and the plurality of batteries are laid flat on the bracket 150. Similarly, laying the batteries 120 flat is also to reduce the axial space occupation. It is easy to know that using ordinary soft pack lithium batteries is also an optional solution, with a thickness not exceeding a thickness of the motor 130. In an implementation mode, a protective shell is installed on an outer side of the battery 120 so as to fix and protect the battery 120, thereby avoiding potential safety hazards caused by a collision of the battery 120.

Based on the above internal layout, when a size of the power-assisted wheel assembly is selected as conventional 12-inch size, an overall thickness can be reduced to 46-63 millimeters, which is almost the same as the wheel size of ordinary baby strollers, ball carts and other hand carts. In addition to a portability of an ordinary such hand cart, it can also achieve wheel replacement of the same specifications. Combined with wireless remote control, it can achieve a function of converting the ordinary hand cart into an electric power assisted cart.

In an implementation mode, an output end of the motor 130 passes through one side of the bracket 150 and protrudes from the other side of the bracket 150, the synchronous wheel 160 is provided between the wheel hub 100 and the bracket 150 and provided on the other side of the bracket 150.

The synchronous wheel 160 is fixedly connected to the wheel hub 100. The synchronous wheel 160 and the output end of the motor 130 are transmitted through the belt 170. The output end of the motor 130 drives the synchronous wheel 160 to rotate through the belt 170, and indirectly drives the wheel hub 100 to rotate, thereby achieving power assistance.

It can be understood that in this embodiment, a rotation of the wheel hub 100 is directly driven by the motor, and its deceleration is also directly reduced by a drag effect of the motor. Specifically, when a vehicle needs to slow down, the power supply to the motor is disconnected. The motor is dragged by the synchronous wheel 160 under an inertia of the vehicle and generates electrical energy, which in turn charges the battery so as to achieve kinetic energy recovery and deceleration.

In an implementation mode, a gear ratio of the synchronous wheel 160 to the motor 130 is 10:1. After testing, for a handcart product with a load capacity of less than 10 kilograms, the gear ratio of 10:1 has sufficient torque and can achieve significant deceleration on slopes below 30 degrees.

In an implementation mode, the wheel axle 300 is a quick detachable axle, and includes a hollow axle body 310, a lock rod 320 provided in the axle body 310, a bead 330 provided at one end of the axle body 310 that is connected to the vehicle, a button 340 provided at the other end of the axle body 310, and a spring 350 provided between the axle body 310 and the lock rod 320.

The button 340 is exposed outside one side of the wheel hub 100.

The lock rod 320 is provided with a step 321 at a position that the lock rod 320 contacts to the bead 330.

When the button 340 is pressed, the lock rod 320 is moved towards the vehicle, and the bead 330 is moved. When the button 340 is released, the lock rod 320 is rested and the bead 330 is locked under an elastic force of the spring 350.

Combining the quick detachable axle 300 and wireless control form mentioned above, a convenience of disassembling the wheel assembly is further enhanced.

The present disclosure further provides a rollator, including the above power-assisted wheel assembly. The rollator can be any handcart such as a baby stroller, a golf cart, a camping cart, etc. The power-assisted wheel assembly provides power assistance on the rollator, saving effort for a user.

The above description is only preferred embodiments of the present disclosure and does not limit the present disclosure in any form. Although the present disclosure has been disclosed in preferred embodiments, it is not intended to limit the present disclosure. Those skilled in the art who is familiar with this field can use the disclosed technical solution to make minor changes or modifications to equivalent embodiments without departing from the scope of the technical solution of the present disclosure. Any simple modifications, equivalent changes, and modifications made to the above embodiments based on the technical essence of the present disclosure without departing from the technical solution of the present disclosure still belong to the scope of the technical solution of the present disclosure.

What is claimed is:

1. A power-assisted wheel assembly that integrates with drive and power supply, comprising a wheel hub, a tire sleeved on the wheel hub, a wheel axle being capable of rotating relative to the wheel hub, and a closed accommodation cavity provided in the wheel hub;
wherein the accommodation cavity is provided with a battery and a motor, the motor is connected to the wheel hub for transmission;
the accommodation cavity is further provided with an electronic control board, which is electrically connected to the battery and the motor; the battery supplies power to the electronic control board and the motor;
the electronic control board is wirelessly connected to a remote control for controlling an operation of the motor.

2. The power-assisted wheel assembly according to claim 1, wherein a bracket is provided in the accommodation cavity, and the bracket is fixedly connected to the wheel axle;
the bracket is a flat plate;
the battery, the motor, and the electronic control board are all fixed on a same side of the bracket.

3. The power-assisted wheel assembly according to claim 2, wherein the battery is a combination of a plurality of batteries, and the plurality of batteries are laid flat on the bracket.

4. The power-assisted wheel assembly according to claim 2, wherein an output end of the motor passes through one side of the bracket and protrudes from the other side of the bracket;
a synchronous wheel is provided between the wheel hub and the bracket and provided on the other side of the bracket;
the synchronous wheel is fixedly connected to the wheel hub, the synchronous wheel and the output end of the motor are transmitted through a belt.

5. The power-assisted wheel assembly according to claim 4, wherein a gear ratio between the synchronous wheel and the motor is 10-1..

6. The power-assisted wheel assembly according to claim 1, wherein the wheel axle is a quick detachable axle, and comprises a hollow axle body, a lock rod provided in the axle body, a bead provided at one end of the axle body that is connected to a rollator, a button provided at the other end of the axle body, and a spring provided between the axle body and the lock rod;
the button is exposed outside one side of the wheel hub;
the lock rod is provided with a step at a position that the lock rod contacts to the bead;
when the button is pressed, the lock rod is moved towards the rollator, and the bead is moved;
when the button is released, the lock rod is rested, and the bead is locked under an elastic force of the spring.

7. A rollator, comprising the power-assisted wheel assembly according to claim 1.
